(19) United States
(12) Patent Application Publication
(10) Pub. No.: US 2026/0041109 A1
(43) Pub. Date: Feb. 12, 2026

(54) ROBUST FLAVOR EMULSIONS

(71) Applicant: International Flavors & Fragrances, Inc., New York, NY (US)

(72) Inventors: Daniel Kaiping Lee, Union Beach, NJ (US); Ronald Gabbard, Union Beach, NJ (US); Adam Toth, Union Beach, NJ (US); Nicholas Christian Apollo, Union Beach, NJ (US)

(21) Appl. No.: 18/998,572

(22) PCT Filed: Jul. 18, 2023
(86) PCT No.: PCT/US2023/070404

§ 371 Date: Jan. 27, 2025

Related U.S. Application Data
(60) Provisional application No. 63/392,141, filed on Jul. 26, 2022.

(51) Int. Cl. A23D 7/005; A23D 7/02; A23L 2/56; A23L 2/60; A23L 27/00; A23L 27/10; A23L 29/25

(52) U.S. Cl. CPC A23D 7/0053; A23D 7/02; A23L 2/56; A23L 2/60; A23L 27/10; A23L 27/80; A23L 29/25

(57) ABSTRACT

An oil-in-water emulsion is disclosed. The oil-in-water emulsion contains an oil phase, an aqueous phase, and an emulsifier system with one or more types of acacia gum. Also disclosed are consumer products and methods of preparing the oil-in-water emulsion.

### CROSS-REFERENCE TO RELATED PATENT APPLICATION

This application claims priority to U.S. Application Ser. No. 63,392,141, the disclosure of which is incorporated by reference herein.

### BACKGROUND

Oil-in-water emulsions are important constituents of many commercial products, including foods and beverages, supplements, pharmaceuticals, cosmetics, personal care products, and agrochemicals. This type of colloidal dispersion is composed of small oil droplets dispersed within an aqueous continuous phase. Due to different physicochemical properties of functional ingredients, such as polarity, solubility, molecular weight, molecular conformation, and surface tension, to name a few, emulsions are thermodynamically unstable, and therefore tend to breakdown over time due to various physicochemical mechanisms, including gravitational separation, flocculation, coalescence, particle coalescence, Ostwald ripening, phase separation, creaming, oiling, or a combination thereof. As such, stabilizers may be included in emulsion formulations to improve their long-term stability, such as emulsifiers, texture modifiers, ripening inhibitors, and weighting agents.

Emulsifiers are one of the most important stabilizers used in any emulsion formulation. In addition to their ability to stabilize emulsions, the nature of the emulsifier used also determines the ease of emulsion formation and the functional attributes of the final product. Consequently, selection of an appropriate emulsifier is one of the most important decisions when formulating emulsion-based products. Emulsifiers are typically amphiphilic molecules that have both hydrophilic and hydrophobic groups on the same molecule, such as small molecule surfactants, phospholipids, proteins, polysaccharides, and other surface-active polymers. However, traditional emulsifier systems such as those including gum acacia suffer from inconsistent performance and the resulting shortened stability or shelf-life for consumable products containing those oil-in-water emulsions. Notably, consumable products including flavors and flavor modulators can substantially destabilize oil-in-water emulsions.

Current oil-in-water emulsions such as those described in EP3328901B1 have used various types of gum acacia and attempt products stability problem by specifying an amount of tannins. In EP3097790B1, gum acacia forms a part of an oil-in-water emulsion that attempts to provide high turbidity with acceptable stability by managing the overall composition of the oil-in-water emulsion.

Many flavoring compounds in beverage preparations are essential oils such as orange, lemon, and grapefruit, which have limited water solubility. In many instances, it is desirable to include flavor modulators such as sweetness modulators to improve the performance and/or taste of such flavor emulsions. In addition, sweetness modulators have been recognized as providing certain health benefits. See WO 2017/218072 A1 and WO 2009/085762 A1. However, flavor modulators have the propensity to destabilize oil-in-water emulsions, a problem which has not been addressed in the art.

Thus, there is a need to develop a robust emulsion that allows a broader palette of functional ingredients in food, beverage, and pharmaceutical products without sacrificing stability.

### SUMMARY OF THE INVENTION

This invention provides an oil-in-water emulsion composed of (i) an oil phase comprising at least one first functional ingredient, (ii) a first aqueous phase comprising at least one acacia gum emulsifier comprising arabinogalactan-protein, and (iii) a second aqueous phase comprising at least one second functional ingredient, wherein the oil-in-water emulsion comprises a plurality of oil droplets each having a mean droplet size of from about 0.1 μm to about 1 μm in diameter, and the weight ratio of arabinogalactan-protein to oil is at least 1:10. In some aspects, the arabinogalactan-protein content of the emulsion is at least 1.0% w/w by weight, the weight ratio of acacia gum emulsifier to oil is at least 1:1.3 and/or the viscosity of the emulsion is at least 30 cPs. In other aspects, the first functional ingredient is at a flavor oil, a weighting agent, a lipid, an antioxidant, an opacifier/cloudifier, or combinations thereof. In other aspects, the second functional ingredient is a taste modifier (e.g., a sweetness modifier such as a steviol-based compound, a non-steviol-based compound, or combinations thereof), an acidulant, a preservative, a carbohydrate, a nutraceutical ingredient, a colorant, a juice, a plant extract, a vitamin, or combinations thereof. In certain aspects, the second functional ingredient is present in an amount of from about 0.1% to about 5% w/w by weight of the oil-in-water emulsion. In certain aspects, the first functional ingredient is present in an amount of from 0.01% to 15% w/w by weight of the oil-in-water emulsion. In a further aspect, the oil-in-water emulsion includes a co-emulsifier, e.g., second acacia gum emulsifier. A method of preparing an oil-in-water emulsion is also provided, and includes the steps of (a) emulsifying a first aqueous phase with an oil phase thereby obtaining an oil-in-water emulsion, the oil phase comprising a first functional ingredient and the first aqueous phase comprising at least one acacia gum emulsifier comprising arabinogalactan-protein, and (b) admixing a second aqueous phase with the oil-in-water emulsion to form a final oil-in-water emulsion, the second aqueous phase comprising a second functional ingredient, wherein the final oil-in-water emulsion comprises a plurality of oil droplets each having a mean droplet size of from about 0.1 μm to about 1 μm in diameter, and the weight ratio of arabinogalactan-protein to oil is at least 1:10. In one aspect, the emulsifying step comprises high pressure homogenization with operation pressures up to 30,000 psi. In other aspects, the arabinogalactan-protein content of the oil-in-water emulsion is at least 1.0% w/w by weight, the weight ratio of acacia gum emulsifier to oil is at least 1:1.3 and/or the oil-in-water emulsion is at least 30 cPs. In certain aspects, the second functional ingredient is a taste modifier (e.g., a sweetness modifier), an acidulant, a preservative, a carbohydrate, a nutraceutical ingredient, a colorant, a juice, a plant extract, a vitamin, or combinations thereof. In further aspects, the method further includes the use of a co-emulsifier, e.g., a second acacia gum emulsifier In a still further embodiment of the invention, one can add at least one second functional ingredient in the first aqueous phase provided that the second functional ingredient has the following described specified chemical characteristics. Thus, one can admix both the first aqueous phase including at least one second functional ingredient and the second aqueous phase to form a resulting final oil-in water emulsion provided that the at least one second functional ingredient included in the first aqueous phase does not destabilize the emulsion or induce lifting or separation of the final emulsion. Notably, some second functional ingredients should not be included in the first aqueous phase. A second functional ingredient which is surface active and amphiphilic, prevents formation of an emulsion and thus causes destabilization if such a second functional ingredient is introduced in the first aqueous phase. Accordingly, a second functional ingredient, if introduced in the first aqueous phase, should be non-amphiphilic. In one example, a surface-active functional ingredient which is amphiphilic and leads to the mentioned destabilization is a steviol-based compound.

### DETAILED DESCRIPTION OF THE INVENTION

The examples provided in the detailed description are merely examples and should not be used to limit the scope of the claims in any claim construction or interpretation. This invention provides robust oil-in-water emulsions that allow for the stable delivery of a broader palette of flavor oils (e.g., citrus and non-citrus flavor tonality) as well as other functional ingredients such as weighting agents, lipids, antioxidants, opacifier/cloudifiers, taste modifiers (e.g., sweetness modifiers), acidulants, preservatives, carbohydrates, nutraceutical ingredients, colorants, juices, plant extracts, vitamins, or combinations thereof, by including in the emulsion at least one acacia gum emulsifier, which comprises arabinogalactan-protein, such that the weight ratio of arabinogalactan-protein to oil is at least 1:10. Moreover, when functional ingredients that have a tendency to break an emulsion are to be included in the oil-in-water emulsion, it has been found that a stable oil-in-water emulsion can be prepared when said functional ingredients are added after the oil-in-water emulsion has already been formed.

For the purposes of this invention, an oil-in-water emulsion comprises an oil phase and at least one aqueous phase. In such oil-in-water emulsions, the oil phase includes a plurality of oil droplets each having a mean droplet size of from about 0.1 μm to about 5 μm, or more preferably about 0.1 μm to about 1 μm in diameter, or most preferably about 0.1 μm to about 0.7 μm in diameter and the oil phase contains a first functional ingredient comprising a flavor oil, a weighting agent, a lipid, an antioxidant, an opacifier/cloudifier, or combinations thereof. The flavor oil may comprise essential oils, flavor ingredients, and optionally solvents. In accordance with this invention, the emulsion is composed of the oil phase dispersed in a first aqueous phase which includes an acacia gum emulsifier that is composed of inter alia arabinogalactan-protein, wherein said emulsion is admixed with a second aqueous phase that includes a second functional ingredient comprising a taste modifier, an acidulant, a preservative, a carbohydrate, a nutraceutical ingredient, a colorant, a juice, a plant extract, a vitamin, or combinations thereof. For example, the taste modifier can include (e.g., a sweetness modifier such as a steviol-based compound, a non-steviol-based compound or combinations thereof.)

Surprisingly and unexpectedly, these oil-in-water emulsions have been found to have stability despite the inclusion of a second functional ingredient which can include one example of an amphiphilic taste modulator such as a sweetness modulator including a steviol-based compound as such sweetness modulator has been shown to destabilize typical oil-in-water emulsions. As mentioned previously, an amphiphilic taste modulator should not be introduced in the first aqueous phase and is added after the oil-in-water emulsion has already been formed.

Without being bound by theory, it is believed that stability can be attributed to (i) the inclusion of at least one acacia gum emulsifier comprising arabinogalactan-protein, wherein the weight ratio of arabinogalactan-protein to oil is at least 1:10 and/or (ii) formation of the emulsion prior to the addition of the second functional ingredient.

In some aspects, the arabinogalactan-protein of the acacia gum emulsifier has a weight average molecular weight in the range of 2×10⁶ Dalton to 6×10⁶ Dalton. In other aspects, the arabinogalactan-protein content of the of the acacia gum emulsifier is in the range of 10% to 20% w/w of the acacia gum emulsifier. In further aspects, the arabinogalactan-protein content of the emulsion is at least 1.0%, 1.1%, 1.2%, 1.3%, 14. %, 1.5%, 1.6%, 1.7%, 1.8%, 1.9%, 2.0%, 2.1%, 2.2%, 2.3%, 2.4%, 2.5%, 2.6%, 2.7%, 2.8%, 2.9%, 3.0%, 3.1%, 3.2%, 3.3%, 3.4%, 3.5%, 3.6% or up to 5.0% by weight (w/w) of the emulsion. In a particular aspect, the weight ratio of arabinogalactan-protein to oil in the emulsion is at least 1:10, 1:9, 1:8, 1:7, 1:6, 1:5, 1:4, 1:3, or 1:2. In certain the ratio of aspects, weight arabinogalactan-protein to oil in the emulsion is in the range of 1:10 to 1:2, or more preferably 1:10 to 1:3. In still other aspects, the acacia gum emulsifier has a weight ratio of arabinogalactan-protein to arabinogalactan of at least 0.25.

In some aspects, the emulsifier system is present in an amount of from about 1% to about 30% w/w by weight of the oil-in-water emulsifier system. In other aspects, the emulsifier system is present in an amount of from about 1%, 2%, 3%, 4%, 5%, 6%, 7%, 8%, 9%, 10%, 11%, 12%, 13%, 14%, 15%, 16%, 17%, 18%, 19%, 20%, 21%, 22%, 23%, 24%, 25%, 26%, 27%, 28%, or 29% to about 2%, 3%, 4%, 5%, 6%, 7%, 8%, 9%, 10%, 11%, 12%, 13%, 14%, 15%, 16%, 17%, 18%, 19%, 20%, 21%, 22%, 23%, 24%, 25%, 26%, 27%, 28%, 29%, or 30% w/w by weight of the oil-in-water emulsion system.

Furthermore, in some aspects, the oil-in-water emulsion has a weight ratio of acacia gum emulsifier to oil phase in the range of from about 1:10 to about 2:1. In other aspects, the weight ratio of emulsifier system to oil phase is from about 1:5 to about 1:2, while in still other aspects, the ratio of emulsifier system to oil phase is from about 1:5 to about 1:1, or more preferably 1:1.3 to 1:1.

For the purpose of this invention, stability is defined as flavor quality and intensity along with emulsion homogeneity that remains acceptable for use in end-use applications. Preferably, a stable emulsion has a shelf-life of at least one year to three years depending on storage conditions. Stability can be assessed by the methods disclosed herein, for example by storing the emulsion for a specified period of time (e.g., 1 day, 1 month, 1 year and the like) at a specified temperature (e.g., an elevated temperature such as 40° C. or 57° C.) and monitoring oil droplet size and/or emulsion homogeneity. Emulsions that fail to exhibit substantial gravitational phase separation, flocculation, coalescence, creaming, and/or oiling are deemed to be stable. An explanation of some of the foregoing terms are now explained. Flocculation is a “process whereby two or more droplets ‘stick’ together to form an aggregate in which each of the initial droplets retains its individual integrity.” Critical Reviews in Food Science and Nutrition, 47:611-649 (2007) at 613 (hereinafter, “Critical Reviews.”) Such oil droplets in the mentioned aggregate, as contemplated in this specification, can be separated by mechanical mixing or shaking, for example.

Coalescence occurs when individual oil droplets merge together from the droplet clusters to form larger droplets, resulting in a decreased number of droplets. Creaming occurs when the emulsion separates and oil droplets float to the top, forming a creamy ring at the neck of the bottle. When emulsion further breaks down, an oily ring is formed. Such droplets “move upward” (‘creaming’) because they have a lower density than the surrounding liquid.” Critical Reviews.

Stable oil-in-water emulsions can have certain desirable physical properties such as oil droplet diameter size, viscosity, oil phase density, and water activity. As mentioned above, in some aspects, the oil-in-water emulsions of these inventions have mean oil droplet sizes from about 0.1 microns to about 5 microns. In other aspects, the mean oil droplet size is from about 0.1, 0.2, 0.3, 0.4, 0.5, 0.6, 0.7, 0.8, 0.9, 1, 1.1, 1.2, 1.3, 1.4, 1.5, 1.6, 1.7, 1.8, 1.9, 2, 2.5, 3, 3.5, 4, or 4.5, to about 0.2, 0.3, 0.4, 0.5, 0.6, 0.7, 0.8, 0.9, 1, 1.1, 1.2, 1.3, 1.4, 1.5, 1.6, 1.7, 1.8, 1.9, 2, 2.5, 3, 3.5, 4, 4.5, or 5 microns. In still other aspects, the mean oil droplet size is from about 0.1 microns to about 1 micron. Oil droplet size can be measured using various methods as readily known by persons of ordinary skill in the art. In some aspects, the mean oil drop size can be measured using a Coulter Counter Model LS 13 320 particle size analyzer (as sold by Beckman Coulter Life Sciences, Indianapolis, IN).

In certain aspect, the inventive oil-in-water emulsions have a viscosity of at least 30 cPs. In other aspects, the viscosity is in the range of 30 cPs to 1000 cPs, or more preferably in the range of 30 cPs to 750 cPs, or most preferably in the range of 30 cPs to 500 cPs. Viscosity can be measured by conventional methods as readily known to persons of ordinary skill in the art and include, e.g., the use of a Brookfield Viscometer (Model DV-III) with Spindle #4 at a speed of 60 rpm.

In some aspects, the inventive oil-in-water emulsions have a phase density of from about 0.9 g/L to about 1.1 g/L. In other aspects, the oil phase has a density of from about 0.9, 0.95, 0.99, or 1.0 g/L to about 0.95, 0.99, 1.0 or 1.1 g/L.

In still other aspects, the inventive oil-in-water emulsions have a water activity of from about 0.90 to about 0.99. Water activity is the ratio between the vapor pressure of the emulsion, when in a completely undisturbed balance with the surrounding air media, and the vapor pressure of distilled water under identical conditions. A water activity of 0.9 means the vapor pressure is 90 percent of that of pure water. Using this particular definition, pure distilled water has a water activity of exactly one. Water activity can be measured, for example, by using AQUALAB Model 4TE (sold by Decagon Devices, Inc., Court Pullman, WA). Other ways of measuring water activity are readily known to persons of ordinary skill in the art.

The amount of each phase in the oil-in-water emulsion, including relative amount of the inventive oil-in-water emulsion, can play a role in providing the desired stability of the oil-in-water emulsions. In some aspects, the oil phase is present in an amount of from about 0.5% to about 30% w/w by weight of the oil-in-water emulsion. In other aspects, the oil phase is present in an amount of from about 0.5%, 18, 2%, 2.5%, 5%, 10%, 15%, 20%, or 25% to about 18, 2%, 2.5%, 5%, 10%, 15%, 20%, 25%, or 30% w/w by weight of the oil-in-water emulsion.

First functional ingredient. In some aspects, the first functional ingredient in the first aqueous phase includes a flavor oil, a weighting agent, a lipid, an antioxidant, an opacifier/cloudifier, or combinations thereof. In some aspects, the flavor oil includes essential oils, flavor ingredients or combinations thereof. Additionally, flavor oils suitable for preparing the emulsions of these inventions can include one or more volatile and nonvolatile compounds. A variety of flavor oils can be used in accordance with the present claimed inventions. Flavor oils may contain synthetic flavor ingredients, essential oils and oil extracts derived from plants, leaves, flowers, fruits, or combinations thereof. Without being bound by example representative essential oils include, but are not limited to, spearmint oil, cinnamon oil, peppermint oil, clove oil, bay oil, thyme oil, cedar leaf oil, oil of nutmeg, oil of sage, and oil of bitter almonds. Also useful are artificial, natural or synthetic fruit flavors such as vanilla, chocolate, coffee, cocoa and citrus oil, including lemon, orange, grape, lime and grapefruit, and fruit essences including apple, pear, peach, strawberry, watermelon, raspberry, cherry, plum, pineapple, apricot and so forth. These flavors can be used individually or in admixture.

Volatile compounds in flavor oils. Volatile compounds in the flavor oils may include, but are not limited to, acetaldehyde, dimethyl sulfide, ethyl acetate, ethyl propionate, methyl butyrate, and ethyl butyrate. Flavors containing volatile aldehydes or esters include, e.g., cinnamyl acetate, cinnamaldehyde, citral, diethylacetal, dihydrocarvyl acetate, eugenyl formate, and p-methylanisole. Further examples of volatile compounds that may be present in the flavor oils include acetaldehyde (apple); benzaldehyde (cherry, almond); cinnamic aldehyde (cinnamon); citral, i.e., alpha citral (lemon, lime); neral, i.e., beta citral (lemon, lime); decanal (orange, lemon); ethyl vanillin (vanilla, cream); heliotropine, i.e., piperonal (vanilla, cream); vanillin (vanilla, cream); alpha-amyl cinnamaldehyde (spicy fruity flavors); butyraldehyde (butter, cheese); valeraldehyde (butter, cheese); citronellal (modifies, many types); decanal (citrus fruits); aldehyde C-8 (citrus fruits); aldehyde C-9 (citrus fruits); aldehyde C-12 (citrus fruits); 2-ethyl butyraldehyde (berry fruits); hexenal, i.e., trans-2 (berry fruits); tolyl aldehyde (cherry, almond); veratraldehyde (vanilla); 2,6-dimethyl-5-heptenal, i.e., melonal (melon); 2-6-dimethyloctanal (green fruit); and 2-dodecenal (citrus, mandarin); cherry; or grape and mixtures thereof. The composition may also contain taste modulators and artificial sweeteners.

Weighting agents in first functional ingredients. In some aspects, the first functional ingredient includes a weighting agent wherein the weighting agent includes at least an ester gum, a diacetate hexaisobutyrate, a brominated vegetable oil, a sucrose acetate isobutyrate, a damar gum, or combinations thereof. These materials modify the specific gravity of the oil phase to limit the separation of the oil phase from the aqueous phase. The amount of weighting agent is limited by food regulations, taste impact, and the ability of the weighting agent to perform its function. Those skilled in the art will be familiar with typical inclusion amounts based on final use applications.

Lipids in first functional ingredients. In addition to weighting agents, the first functional ingredient system can also include a lipid. The lipid helps provide desired opacity to consumer products like beverage products that include the oil-in-water emulsion. In some aspects, the lipid includes a medium chain triglyceride, a coconut oil, a sunflower oil, a palm kernel oil, a caprylic triglyceride, a caprylic/capric triglyceride, or combinations thereof. Similarly, the first functional ingredient can include a commercially-available cloudifier/opacifier. Those of skill in the art will be familiar with these products.

Antioxidants in first functional ingredients. In some aspects, the first functional ingredient system includes an antioxidant to provide oxidative stability. Suitable antioxidants can include beta-carotene, vitamin C (Ascorbic Acid) or an ester thereof, vitamin A or an ester thereof, vitamin E or an ester thereof, tocopherols, lutein or an ester thereof, lignan, lycopene, selenium, flavonoids, polyphenols, extracts such as rosemary extract, carnosic acid, vitamin-like antioxidants such as coenzyme Q10 (CoQ10) and glutathione, or antioxidant enzymes such as superoxide dismutase (SOD), catalase, or glutathione peroxidase.

Second functional ingredient. Turning to the aqueous phase of the oil-in-water emulsion, in some aspects, the second aqueous phase contains at least one second functional ingredient. In other aspects, the second functional ingredient includes a taste modifier, an acidulant, a preservative, a carbohydrate, a nutraceutical ingredient, a colorant, a juice, a plant extract, a vitamin, or combinations thereof. In some of these aspects, the second functional ingredient is present in an amount of from about 0.1% to about 5% w/w by weight of the oil-in-water emulsion. In other aspects, the second functional ingredient is present in an amount of from about 0.18, 0.25%, 0.5%, 0.75%, 1%, 1.25%, 1.5%, 1.75%, 2%, 2.25%, 2.5%, 2.75%, 3%, 3.25%, 3.5%, 3.75%, 4%, 4.25%, 4.5%, or 4.75% to about 0.25%, 0.5%, 0.75%, 1%, 1.25%, 1.5%, 1.75%, 2%, 2.25%, 2.5%, 2.75%, 3%, 3.25%, 3.5%, 3.75%, 4%, 4.25%, 4.5%, 4.75%, or 5% w/w by weight of the oil-in-water emulsion.

Taste modifier in second functional ingredients. As used herein, a “taste modifier” is an ingredient that alters sweetness quality, increases or reduces intensity, or masks aftertaste. Not to be bound by theory, it is posited that taste modifiers function by exerting a physical or chemical effect on the stimulus rather than the taste receptor. Some taste modifiers include one or more amphiphilic compounds which are surface active and disrupt the homogeneity of an oil-in-water emulsion, thereby rendering it unacceptable for use in consumer product applications. Thus, in certain aspects of the claimed invention, the taste modifier can include at least one amphiphilic taste modifier, when such taste modifier is not used in a pre-emulsion, where such taste modifier is included prior to the emulsion formation phase. In particular aspects, the taste modifier is a sweetness modifier. Exemplary sweetness modifiers include steviol-based compounds, non-steviol-based compounds, or combinations thereof. Suitable sweetness modifiers are known in art. See, e.g., US 2015/0272184 A1, US 2022/0046970 A1, US 2021/0177023 A1, and US 2021/0251267 A1 to International Flavors & Fragrances Inc. In some aspects, the non-steviol-based compound includes a Luo Han fruit extract. In certain aspects, the sweetness modifier is stevioside, steviolbioside, rebaudioside A, rebaudioside B, rebaudioside C, rebaudioside D, rebaudioside E, rebaudioside F, dulcoside A, dulcoside B, rubusoside, alpha-glucosyl stevia, fructosyl stevia, galactosyl stevia, beta-glucosyl stevia, siamenoside, mogrosidc IV, mogroside V, Luo Han Guo, monatin, glycyrrhizic acid, verbascoside, secoiridoid glucoside, ligustrosidic acid, thaumatin, a salt thereof, a glycosylated derivative thereof or a combination thereof. As demonstrated below, taste modifiers can have a destabilizing effect on the oil-in-water emulsion and the inclusion of the acacia gum emulsifier surprisingly provides an oil-in-water emulsion with a long shelf-life of one year or more. In the absence of an acacia gum emulsifier, an oil-in-water emulsion would not form at all.

Other examples of taste modifiers in second functional ingredients. Other taste modifiers can include:
(ii) taste masking agents, substances for masking one or more unpleasant taste sensations, in particular a bitter, astringent and/or metallic taste sensation or aftertaste. Examples include lactisol [2O-(4-methoxyphenyl) lactic acid] (cf. U.S. Pat. No. 5,045,336), 2,4-dihydroxybenzoic acid potassium salt (cf. U.S. Pat. No. 5,643,941), ginger extracts (cf. GB 2,380,936), neohesperidine dihydrochalcone (cf. Manufacturing Chemist 2000 July issue, p. 16-17), specific flavones (2-phenylchrom-2-en-4-ones) (cf. U.S. Pat. No. 5,580,545), specific nucleotides, for example cytidine-5′-monophosphates (CMP) (cf. US 2002/0177576), specific sodium salts, such as sodium chloride, sodium citrate, sodium acetate and sodium lactate (cf. Nature, 1997, Vol. 387, p. 563), a lipoprotein of beta-lactoglobulin and phosphatidic acid (cf. EPA 635218), neodiosmine [5,7-dihydroxy-2-(4-methoxy-3-hydroxyphenyl)-7-O-neohesperidosyl-chrom-2-en-4-one] (cf. U.S. Pat. No. 4,154,862), preferably hydroxyflavanones according to EP 1258200, in turn preferred in this respect 2-(4-hydroxyphenyl)-5,7-dihydroxychroman-4-one (naringenin), 2-(3,4-dihydroxyphenyl)-5,7-dihydroxychroman-4-one (eriodictyol), 2-(3,4-dihydroxyphenyl)-5-hydroxy-7-methoxychroman-4-one (eriodictyol-7-methylether), 2-(3,4-dihydroxyphenyl)-7-hydroxy-5-methoxychroman-4-one (eriodictyol-5-methylether) and 2-(4-hydroxy-3-methoxyphenyl)-5,7-dihydroxychroman-4-one (homoeriodictyol), the (2S)- or (2R)-enantiomers thereof or mixtures thereof as well as the mono- or polyvalent phenolate salts thereof with Na⁺, K⁺, NH4⁺, Ca²⁺, Mg²⁺ or Al³⁺ as counter cations or γ-aminobutyric acid (4-aminobutyric acid, as the neutral form (“inner salt”) or in the carboxylate or ammonium form) according to WO 2005/09684; and
(ii) taste sensates including hot tasting, salivation-inducing substances, substances causing a warmth or tingling feeling, and cooling active ingredients. Examples of hot tasting and/or salivation-inducing substances and/or substances which cause a feeling of warmth and/or a tingling feeling on the skin or on the mucous membranes and which can be a constituent of the products according to the invention are: capsaicin, dihydrocapsaicin, gingerol, paradol, shogaol, piperine, carboxylic acid-N-vanillylamides, in particular nonanoic acid-N-vanillylamide, pellitorin or spilanthol, 2-nonanoic acid amides, in particular 2-nonanoic acid-N-isobutylamide, 2-nonanoic acid-N-4-hydroxy-3-methoxyphenylamide, alkyl ethers of 4-hydroxy-3-methoxybenzyl alcohol, in particular 4-hydroxy-3-methoxybenzyl-n-butylether, alkyl ethers of 4-acyloxy-3-methoxybenzyl alcohol, in particular 4-acetyloxy-3-methoxybenzyl-n-butylether and 4-acetyloxy-3-methoxybenzyl-n-hexylether, alkyl ethers of 3-hydroxy-4-methoxybenzyl alcohol, alkyl ethers of 3,4-dimethoxybenzyl alcohol, alkyl ethers of 3-ethoxy-4-hydroxybenzyl alcohol, alkyl ethers of 3,4-methylene dioxybenzyl alcohol, (4-hydroxy-3-methoxyphenyl) acetic acid amides, in particular (4-hydroxy-3-methoxyphenyl) acetic acid-N-n-octylamide, vanillomandelic acid alkylamides, ferulic acid-phenethylamides, nicotinaldehyde, methylnicotinate, propylnicotinate, 2-butoxyethylnicotinate, benzylnicotinate, 1-acetoxychavicol, polygodial and isodrimeninol, further preferred cis- and/or trans-pellitorin according to WO 2004/000787 or WO 2004/043906, alkenecarboxylic acid-N-alkylamides according to WO 2005/044778, mandelic acid alkylamides according to WO 03/106404 or alkyloxyalkanoic acid amides according to WO 2006/003210. Examples of preferred hot tasting natural extracts and/or natural extracts which cause a feeling of warmth and/or a tingling feeling on the skin or on the mucous membranes and which can be a constituent of the products according to the invention are: extracts of paprika, extracts of pepper (for example capsicum extract), extracts of chili pepper, extracts of ginger roots, extracts of Aframomum melgueta, extracts of Spilanthes acmella, extracts of Kaempferia galangal or extracts of Alpinia galanga. Suitable cooling active ingredients include the following: 1-menthol, d-menthol, racemic menthol, menthone glycerol acetal (tradename: FRESCOLAT® MGA), menthyl lactate (tradename: FRESCOLAT® ML, menthyl lactate preferably being 1-menthyl lactate, in particular 1-menthyl-1-lactate), substituted menthyl-3-carboxamides (for example menthyl-3-carboxylic acid-N-ethylamide), 2-isopropyl-N-2,3-trimethyl-butanamide, substituted cyclohexane carboxamides, 3-menthoxypropane-1,2-diol, 2-hydroxyethyl menthyl carbonate, 2-hydroxypropyl menthyl carbonate, N-acetylglycine menthyl ester, isopulegol, hydroxycarboxylic acid menthyl esters (for example menthyl-3-hydroxybutyrate), monomenthyl succinate, 2-mercaptocyclodecanone, menthyl-2-pyrrolidin-5-onecarboxylate, 2,3-dihydroxy-p-menthane, 3,3,5-trimethylcyclohexanone glycerol ketal, 3-menthyl-3,6-di- and -trioxaalkanoates, 3-menthyl methoxyacetate and icilin. Cooling active ingredients which are particularly preferred are as follows: 1-menthol, racemic menthol, menthone glycerol acetal (tradename: FRESCOLAT® MGA), menthyl lactate (preferably 1-menthyl lactate, in particular 1-menthyl-1-lactate, tradename: FRESCOLAT® ML), 3-menthoxypropane-1,2-diol, 2-hydroxyethyl menthyl carbonate, 2-hydroxypropyl menthyl carbonate.

Colorants in second functional ingredients. In those aspects where a colorant, an example of a second functional ingredient, is included in the oil-in-water emulsion, the colorant can include, for example, the following dyes, colorants or pigments: lactoflavin (riboflavin), beta-carotene, riboflavin-5′-phosphate, alpha-carotene, gamma-carotene, cantaxanthin, erythrosine, curcumin, quinoline yellow, yellow orange S, tartrazine, bixin, norbixin (annatto, orlean), capsanthin, capsorubin, lycopene, beta-apo-8′-carotenal, beta-apo-8′-carotenic acid ethyl ester, xanthophylls (flavoxanthin, lutein, cryptoxanthin, rubixanthin, violaxanthin, rodoxanthin), fast carmine (carminic acid, cochineal), azorubin, cochineal red A (Ponceau 4 R), beetroot red, betanin, anthocyanins, amaranth, patent blue V, indigotine I (indigo-carmine), chlorophylls, copper compounds of chlorophylls, acid brilliant green BS (lissamine green), brilliant black BN, vegetable carbon, titanium dioxide, iron oxides and hydroxides, calcium carbonate, aluminum, silver, gold, pigment rubine BK (lithol rubine BK), methyl violet B, victoria blue R, victoria blue B, acilan brilliant blue FFR (brilliant wool blue FFR), naphthol green B, acilan fast green 10 G (alkali fast green 10 G), ceres yellow GRN, sudan blue II, ultramarine, phthalocyanine blue, phthalocayanine green, fast acid violet R. Further naturally obtained extracts (for example paprika extract, black carrot extract, red cabbage extract) can be used for coloring purposes. Goods results are also achieved with the colors named in the following, the so-called aluminum lakes: FD & C Yellow 5 Lake, FD & C Blue 2 Lake, FD & C Blue 1 Lake, Tartrazine Lake, Quinoline Yellow Lake, FD & C Yellow 6 Lake, FD & C Red 40 Lake, Sunset Yellow Lake, Carmoisine Lake, Amaranth Lake, Ponceau 4R Lake, Erythrosyne Lake, Red 2G Lake, Allura Red Lake, Patent Blue V Lake, Indigo Carmine Lake, Brilliant blue Lake, brown HT Lake, Black PN Lake, Green S Lake and mixtures thereof.

Co-emulsifiers. In addition to the emulsifier of the inventive oil-in-water emulsions, some aspects also include a co-emulsifier. In some aspects, the co-emulsifier can include a second acacia gum emulsifier. While in still other aspects, the weight ratio of the emulsifier to the co-emulsifier is in the range of from about 1:5 to about 10:1. In some aspects, the weight ratio of the emulsifier system to the co-emulsifier is from about 1:5 to about 3:1. In other aspects, the weight ratio of the emulsifier system to the co-emulsifier is about 1:1, 1:2, or 2:1.

Acidulants in second functional ingredients. In aspects where the second functional ingredient system includes an acidulant, the acidulant can include at acetic acid, citric acid, malic acid, tartaric acid, succinic acid, fumaric acid, lactic acid, benzoic acid, sulfonic acids, ascorbic acid, phosphoric acid, gluconic acid, or combinations thereof. In some aspects, the acidulant is present in an amount of from about 0.1% to about 2% w/w by weight of the oil-in-water emulsion. In other aspects, the acidulant is present in an amount of from about 0.1%, 0.2%, 0.3%, 0.4%, 0.5%, 0.6%, 0.7%, 0.8%, 0.9%, 1%, 1.1%, 1.2%, 1.3%, 1.4%. 1.5%, 1.6%, 1.7%, 1.8%, or 1.9% to about 0.2%, 0.3%, 0.4%, 0.5%, 0.6%, 0.7%, 0.8%, 0.9%, 1%, 1.1%, 1.2%, 1.3%, 1.4%. 1.5%, 1.6%, 1.7%, 1.8%, 1.9%, or 2% w/w by weight of the oil-in-water emulsion.

In addition to providing a taste benefit to the oil-in-water emulsion, the inclusion of an acidulant can affect the pH of the oil-in-water emulsion. In some aspects, the pH of the oil-in-water emulsion has a pH of from about 3.0 to about 5.0. In other aspects, the pH of the oil-in-water emulsion is from about 3.0, 3.1, 3.2, 3.3, 3.4, 3.5, 3.6, 3.7, 3.8, 3.9, 4.0, 4.1, 4.2, 4, 3, 4.4, 4.5, 4.6, 4.7, 4.8 or 4.9 to about 3.1, 3.2, 3.3, 3.4, 3.5, 3.6, 3.7, 3.8, 3.9, 4.0, 4.1, 4.2, 4.3, 4.4, 4.5, 4.6, 4.7, 4.8, 4.9 or 5.0.

Preservatives in second functional ingredients. As mentioned above, the second functional ingredient system can include a preservative. In some aspects, preservatives inhibit or decelerate the growth of microorganisms. In other aspects, preservatives restrict microbial contamination. Growth and/or contamination of microorganisms such as bacteria, yeasts and molds is responsible for quality deterioration or spoilage of foods and beverages, consequently resulting in a short shelf life. Suitable preservatives can include sorbate salts, benzoate salts, calcium disodium EDTA (ethylenediaminetetraacetic acid), sodium polyphosphate, natamycin, cultured dextrose fermentate, plant extracts containing polyphenols (flavonoids, quinones, tannins, etc.), terpenoids, alkaloids, lectins or combinations thereof. Exemplary sorbate salts can include calcium sorbate and potassium sorbate. Exemplary benzoate salts can include sodium benzoate and potassium benzoate.

Carbohydrates in second functional ingredients. As mentioned above, the second functional ingredient system can also include a carbohydrate. In some aspects, the carbohydrate includes a monosaccharide, a disaccharide, a polysaccharide, or combinations thereof. Exemplary monosaccharides can include glucose, fructose, galactose, ribose, and xylose. Exemplary disaccharides can include sucrose, maltose, and lactose. Exemplary polysaccharides can include xanthan gum, guar gum, and pectin.

In some aspects, the carbohydrate is present in an amount of from about 0.1% to about 20% w/w by weight of the oil-in-water emulsion. In other aspects, the carbohydrate is present in an amount of from about 0.1%, 0.5%, 18, 2%, 3%, 4%, 5%, 6%, 7%, 8%, 9%, 10%, 11%, 12%, 13%, 14%, 15%, 16%, 17%, 18%, or 19% to about 0.5%, 1%, 2%, 3%, 4%, 5%, 6%, 7%, 8%, 9%, 10%, 118, 12%, 13%, 14%, 15%, 16%, 17%, 18%, 19%, or 20% w/w by weight of the oil-in-water emulsion.

Nutraceutical ingredient in second functional ingredients. Also, as mentioned above, the second functional ingredient system can include a nutraceutical ingredient. In some aspects, the nutraceutical ingredient can include a cannabidiol, a vitamin, or combinations thereof. Suitable vitamins can include any vitamin, a derivative thereof and a salt thereof. Examples are as follows: vitamin A and its analogs and derivatives (e.g., retinol, retinal, retinyl palmitate, retinoic acid, tretinoin, and iso-tretinoin, known collectively as retinoids), vitamin E (tocopherol and its derivatives), vitamin C (L-ascorbic acid and its esters and other derivatives), vitamin B3 (niacinamide and its derivatives), vitamin D (and its analogs and derivatives), vitamin K (and is analogs and derivatives), or combinations thereof.

Applications of the inventive oil-in-water emulsion. The oil-in-water emulsion can be used in a variety of consumer, food, or pharmaceutical products. In particular and without being bound by application, the flavor emulsion finds application in beverages, gums, confections, oral care products, snacks, dairy products, soups, sauces, and condiments. In some aspects, the consumer product includes a baked good, a dairy product, a fruit ice, a confectionery product, a sugarless candy, a jam, a jelly, a gelatin dessert, a pudding, an animal feed, a pressed confectionery tablet, a hard-boiled candy, a pectin-based candy, a chewy candy, a creme-centered candy, a fondant, a sugarless hard-boiled candy, a sugarless pectin-based candy, a sugarless chewy candy, a sugarless creme-centered candy, a chewing gum, a toothpaste, a mouthwash, a breath freshener, a cough drop, a lozenge, a cough syrup, a decongestant, an antacid, an anti-indigestion preparation, an oral analgesic, or combinations thereof.

In specific aspects, the oil-in-water emulsion is used in beverages, beverage liquid concentrates, or dry beverage powders. Accordingly, in addition to flavor emulsions, the present invention also provides final beverage products or liquid beverage concentrates containing the oil-in-water emulsion of these inventions.

In some aspects, the oil-in-water emulsion is dosed at a level between 1 ppm to 60% (e.g., 1 ppm to 208, 5 ppm to 5%, and 10 ppm to 18) by weight of the final beverage product so that the product contains a flavor oil 0.01 ppm to 10% (0.1 ppm to 5%, 0.5 ppm to 1%, and 1 ppm to 100 ppm). In particular aspects, the final beverage product is cloudy, having a turbidity of at least 100 Nephelometric Turbidity Units (NTU) as measured by a calibrated nephelometer.

Liquid Beverage Concentrate. As used herein, the term “liquid beverage concentrate” means a liquid composition that can be diluted with another liquid, such as an aqueous, potable liquid to provide a final beverage or added to a food product prior to being consumed. The phrase “liquid” refers to a non-gaseous, flowable, fluid composition at room temperature (i.e., 70° F.). The term “final beverage” as used herein means a beverage that has been prepared either by a basic soft drink (i.e., ready-to-drink) preparation procedure or by diluting the concentrate to provide a beverage in a potable, consumable form. An exemplary common basic soft drink preparation procedure includes (1) steps of syrup preparation; (2) a water treatment step including a filtration step; (3) mixing of syrup into filtered water; (4) an optional carbonation step; (5) a step of purifying air and water in bottle and adding the prepared soft drink; and (6) followed by a step of labeling.

In some aspects, the concentrate is non-potable due to acidulant content and/or flavor intensity. By way of example to clarify the term “concentration,” a concentration of 75 times (i.e., “75×”) would be equivalent to 1 part concentrate to 74 parts water (or other potable liquid) to provide the final beverage. In other words, the flavor profile of the final beverage is taken into account when determining an appropriate level of dilution, and thus concentration, of the liquid beverage concentrate. The dilution factor of the concentrate can also be expressed as the amount necessary to provide a single serving of concentrate.

The viscosity, pH, and formulations of the concentrates will depend, at least in part, on the intended dilution factor. In one approach, a moderately concentrated product may be formulated to be diluted by a factor of at least 5 times to provide a final beverage, which can be, for example, an 8-ounce beverage. In one aspect, the concentrate is formulated to be diluted by a factor of 5 to 15 times to provide a final beverage. In this form, the liquid concentrate has a pH of 2.5 to 4.5; and a viscosity of 7.5 to 100 cPs, 10 to 100 cPs, 15 to 100 cPs, 10 to 50 cPs, or 10 to 20 cPs, as measured using Spindle S00 at 50 rpm and 20° C. with a Brookfield DVII+Pro Viscometer.

Acidulant in second functional ingredients. In some aspects, the concentrate includes at least 0.1 to 15 percent acidulant by weight of the concentrate. Any edible, food grade organic or inorganic acid, such as, but not limited to, citric acid, malic acid, succinic acid, acetic acid, hydrochloric acid, adipic acid, tartaric acid, fumaric acid, phosphoric acid, lactic acid, sodium acid pyrophosphate, salts thereof, or combinations thereof can be used, if desired. The selection of the acidulant may depend, at least in part, on the desired pH of the concentrate and/or taste imparted by the acidulant to the diluted final beverage. In another aspect, the amount of acidulant included in the concentrate may depend on the strength of the acid. For example, a larger quantity of lactic acid would be needed in the concentrate to reduce the pH in the final beverage than a stronger acid, such as phosphoric acid. In some aspects, buffer can be added to the concentrate to provide for increased acid content at a desired pH. Suitable buffers include, for example, a conjugated base of an acid, gluconate, acetate, phosphate or any salt of an acid (e.g., sodium citrate and potassium citrate). In other instances, an undissociated salt of the acid can buffer the concentrate. In some aspects, the consumer product has a pH of from about 2.5 to about 4.5.

Concentrates. The beverages or concentrates of these inventions can include one or more juices or juice concentrates (such as at least a 4× concentrated product) from fruits or vegetables for bulk solid addition. In one aspect, the juice or juice concentrate may include, for example, coconut juice (also commonly referred to as coconut water), apple, pear, grape, orange, potato, tangerine, lemon, lime, tomato, carrot, beet, asparagus, celery, kale, spinach, pumpkin, strawberry, raspberry, banana, blueberry, mango, passionfruit, peach, plum, papaya, or combinations thereof. The juice or juice concentrates may also be added as a puree, if desired.

As indicated, concentrates can be added to potable liquids to form flavored beverages. In some aspects, the concentrate may be non-potable (such as due to the high acid content and intensity of flavor). For example, the beverage concentrate can be used to provide flavor to water, cola, carbonated water, tea, coffee, seltzer, club soda, the like, and can also be used to enhance the flavor of juice. In one aspect, the beverage concentrate can be used to provide flavor to alcoholic beverages, including but not limited to flavored champagne, sparkling wine, wine spritzer, cocktail, martini, or the like. In particular aspects, the concentrate is used in an optically clear beverage.

Beverage concentrates can also be combined with a variety of food products to add flavor to the food products. For example, concentrates can be used to provide flavor to a variety of solid, semi-solid, and liquid food products, including but not limited to oatmeal, cereal, yogurt, strained yogurt, cottage cheese, cream cheese, frosting, salad dressing, sauce, and desserts such as ice cream, sherbet, sorbet, and Italian ice. Appropriate ratios of the beverage concentrate to food product or beverage can readily be determined by one of ordinary skill in the art.

Unconventional addition of the second aqueous phase in the invention and unexpected stability. In addition to the compositions described above, a method of preparing a stable oil-in-water emulsion is also provided. Unconventionally, the emulsion preparation method of this invention requires that a second aqueous phase is added to an emulsion after homogenization. That second aqueous phase addition, rather than de-stabilizing the emulsion, provides unexpectedly good stability to the flavor composition.

In some aspects, a method of preparing a flavor composition includes the steps of providing a first aqueous phase containing an acacia gum emulsifier, which includes an arabinogalactan-protein, then providing an oil phase containing a functional first ingredient, followed by emulsifying the oil phase into the first aqueous phase, thereby obtaining the oil-in-water emulsion. Subsequently, a second aqueous phase containing a second functional ingredient system is combined with the oil-in-water emulsion to form a final emulsion, wherein the mean droplet size of from about 0.1 μm to about 1 μm in diameter, and the weight ratio of arabinogalactan-protein to oil is at least 1:10.

Oil-in-water emulsions of the present invention are prepared by emulsifying the oil phase into the aqueous phase in the presence of the acacia gum emulsifier using conventional homogenization techniques as readily known by persons of ordinary skill in the art. Briefly, emulsions are typically prepared by mixing the aqueous and oil phases, and subjecting the mixture to homogenization several times, or, in the terminology of the art, to make more than one “pass.” In accordance with one example of the present invention, a pre-emulsion step (i.e., a high shear mixing step) can be included in the method to set the initial particle size prior to high-pressure homogenization. The speed of high shear mixing may range from 3,000 rpm to 20,000 rpm and the time of mixing may range from 5 to 30 minutes. A high-pressure homogenizer (e.g., commercially available Niro Panda 2000) or other type of homogenizer (e.g., MICROFLUIDIZER® commercially available from Microfluidics or EMULSIFLEX commercially available from Avestin) is subsequently used to prepare the oil-in-water emulsion. Homogenization may be carried out at 2,000 psi or greater, preferably 3,000 psi or greater, for one, two, or more passes. It may also be carried out at 3,000/300 psi to 10,000/1,000 psi or 6,500/500 psi to 20,000/2,000 psi using a two-stage homogenizer for two, three, or more passes.

High Pressure Homogenization. In some aspects, the emulsifying step includes high pressure homogenization with operation pressures up to 30,000 psi. Those of skill in the art will be familiar with the various types of equipment that can be used to homogenize the oil and aqueous phases together including high pressure homogenizers. In some aspects, the high-pressure homogenization step can involve a 2-stage homogenizer wherein the first stage has a pressure of from about 4500 psi to about 5000 psi and the second stage has a pressure of from about 400 to 600 psi. In other aspects, the emulsifying step can include at least 2 passes through the high-speed homogenizer.

Methods of drying. In some aspects, the method of preparing an oil-in-water emulsion can include a step of drying following the step that forms the final emulsion to form a dried composition. Those of skill in the art will be familiar with the various types of equipment that can be used for drying including equipment such as single- and multi-stage spray driers, fluidized bed dryers, drum dryers, vacuum dryers, freeze dryers, infrared dryers, and the like.

Various properties of the final emulsion preparation. As a result of carrying out the methods as described here, the resulting final emulsion can have various properties. In some aspects, the final emulsion has a mean oil droplet size of less than one micron. In other aspects, the final emulsion can have a pH of from about 3.0 to about 5.0 while in still other aspects, the final emulsion can have a water activity of from 0.90 to about 0.99.

Co-emulsifier. In some aspects, the first aqueous phase further contains a co-emulsifier. In some aspects, the co-emulsifier includes a second acacia gum emulsifier. In other aspects, the co-emulsifier includes a second acacia gum emulsifier having an arabinogalactan-protein with a weight average molecular weight of less than 5×10⁶ Dalton.

Improved of the claimed oil-in-water stability emulsions. The stabilized oil-in-water emulsions of this invention exhibit improved stability as measured by various means such as droplet size, ringing, separation, etc. Those of skill in the art will be familiar with these methods of testing emulsion stability. In some aspects, the stabilized oil-in-water emulsions have improved stability through a stability period of from about 8 months to about 18 months.

Enhancement of taste. Methods of enhancing the taste of a consumer product using the oil-in-water emulsions of this invention are also provided. These methods of enhancing the taste of a consumer product employ the steps described above including providing a first aqueous phase containing an acacia gum emulsifier, then providing an oil phase containing a first functional ingredient system, followed by emulsifying the oil phase into the first aqueous phase, thereby obtaining the oil-in-water emulsion, and then providing second aqueous phase containing a second functional ingredient system, after which admixing the second aqueous phase with the oil-in-water emulsion forms a final emulsion and the final emulsion is added to the consumer product.

The so enhanced consumer products can show enhanced tastes as measured by various sensory testing methods such as quantitative descriptive analysis, expert tasting profiling, etc. In some aspects, the consumer product has a higher intensity of juiciness, a higher intensity of sweetness, or combinations thereof as measured by sensory testing.

Other modifications of this invention will be readily apparent to those skilled in the art relying on the teachings of the specification. Such modifications are understood to be within the scope of this invention. In addition, all parts, percentages, proportions, and ratios typically refer to herein and in the claims are by weight unless otherwise specified.

All parts, percentages and proportions refer to herein and in the claims are by weight unless otherwise indicated.

The values and dimensions disclosed herein are not to be understood as being strictly limited to the exact numerical values recited. Instead, unless otherwise specified, each such value is intended to mean both the recited value and a functionally equivalent range surrounding that value. For example, a value disclosed as “50%” is intended to mean “about 50%.”

The terms “include,” “includes,” and “including” are meant to be non-limiting.

All publications cited herein are incorporated by reference in their entirety.

The following non-limiting examples are provided to further illustrate examples of the present invention.

### Example 1: Materials and Methods

As an illustration, oil-in-water emulsions are prepared according to the procedure described below. Briefly, the practice involves preparing first and second aqueous phases by dispersing and dissolving the water-soluble/dispersible dry materials in water until homogeneous and free of lumps. In particular, the first aqueous phase includes an acacia gum emulsifier, an acidulant, and preservatives. An oil phase is prepared with the first functional ingredient, e.g., a flavor oil, a weighting agent, a lipid, an antioxidant, an opacifier/cloudifier, or combinations thereof, and the second aqueous phase includes a second functional ingredient, e.g., a taste modifier, an acidulant, a preservative, a carbohydrate, a nutraceutical ingredient, a colorant, a juice, a plant extract, a vitamin, or combinations thereof. Then the oil phase is added to the first aqueous phase under constant agitation until a uniform mixture is obtained.

A pre-emulsion is prepared by high-shearing the oil dispersed solution with a rotor-stator mixer until a mean droplet size of 5 μm or below is achieved. The pre-emulsion is subsequently processed through high-pressure homogenization to obtain a homogeneous oil-in-water emulsion. The second aqueous phase, which includes at least one second functional ingredient is then mixed with the oil-in-water emulsion to form a final resulting oil-in-water emulsion. Addition of this second aqueous phase after the emulsion is formed provides a significant, measurable improvement in the stability of the emulsion by reducing lifting or separation of the final emulsion.

The resulting emulsion typically contains 50% or more of water. This may be adjusted by using less or more water depending on the solubility of the dry materials, concentration of the oil phase, and various factors related to the efficient operation of the high-shear mixer and high-pressure homogenizer. Emulsions were fabricated using the standard process conditions as shown in the following Table 1. In the Examples below, a batch size of 1000 grams was formulated for each oil-in-water emulsion.

TABLE 1

| | High-shear | High-pressure |
|---|---|---|
| | Mixing | Homogenization |
| Equipment type | SILVERSON L4RT | APV GAULIN |
| Mixing speed | 4000 | |
| (rpm) | | |
| Mixing time | 3 | |
| (minute) | | |
| 1st stage | | 4500 |
| pressure (psi) | | |
| 2^{nd} stage | | 500 |
| pressure (psi) | | |
| Number of | | 3 |
| passes | | |

### Example 2: Emulsions Using Different Sources of Gum Acacia

A flavor emulsion of one example of this invention, i.e., Emulsion I, was prepared according to the process procedure described in Example 1 with the composition provided in the following Table 2 using gum acacia commercially available under the tradename of TICALOID® Acacia MAX (Ingredion Inc., Bridgewater, NJ). Comparative Emulsions I′, II′, III′ and IV′ were prepared following the same procedure as Emulsion I, except that TICALOID® Acacia MAX was replaced with other types of gum acacia under the tradenames of INSTANTGUM™ AA, EFICACIA™ XE, SUPERSTAB™, and SPRAYGUM™ BE (Nexira USA, Somerville, NJ).

Steviol-based compounds functioning as taste modulators were added in the second aqueous phase while all other water-soluble ingredients were added into the first aqueous phase. Preservatives used in this example are a mixture of potassium sorbate and sodium benzoate. The oil phase contained 70 grams of orange flavor (International Flavors and Fragrances, New York, NY) and 55 grams of Ester Gum (Eastman Chemical Company, Kingsport, TN).

TABLE 2

| | Amount in grams | | | | |
|---|---|---|---|---|---|
| Component | I | I′ | II′ | III′ | IV′ |
| Water | 775.4 | 775.4 | 775.4 | 775.4 | 775.4 |
| TICALOID ® Acacia | 75 | | | | |
| MAX | | | | | |
| INSTANTGUM ™ AA | | 75 | | | |
| EFICACIA ™ XE | | | 75 | | |
| SUPERSTAB ™ | | | | 75 | |
| SPRAYGUM ™ BE | | | | | 75 |
| Citric acid | 2.5 | 2.5 | 2.5 | 2.5 | 2.5 |
| Preservatives | 4.1 | 4.1 | 4.1 | 4.1 | 4.1 |
| Steviol-based | 18 | 18 | 18 | 18 | 18 |
| compounds | | | | | |
| Oil phase | 125 | 125 | 125 | 125 | 125 |

Emulsion Physical Stability Physical stability of the flavor emulsion of an example of this invention, i.e., Emulsion I, at time zero and after storage for 4 weeks at 40° C. was compared with that of Emulsion I′, Emulsion II′, Emulsion III′, and Emulsion IV′ as shown in Table 3 as follows. Although Emulsion I, Emulsion I′, Emulsion II′, and Emulsion III′ showed good emulsion physical characteristics, i.e., homogeneous and with no phase separation, at time 0, only Emulsion I of this invention showed surprising and unexpected results with better physical stability (light phase separation) after storage. SPRAYGUM™ BE, being the Seyal species, used in Emulsion IV′ was the least preferred gum acacia for emulsification performance and it stood apart from TICALOID® Acacia MAX, INSTANTGUM™ AA, EFICACIA™ XE, and SUPERSTAB™, which all belong to the Senegal species used in Emulsion I, Emulsion I′, Emulsion II′, and Emulsion III′, respectively. It was not surprising that Emulsion IV′ was not formed properly and showed oiling off at both time 0 and after storage.

TABLE 3

Physical stability

| Emulsion | Time 0 | 4 weeks at 40° C. |
|---|---|---|
| I | − | + |
| I′ | − | ++ |
| II′ | − | ++ |
| III′ | − | ++ |
| IV' | +++ | +++ |

−, no phase separation; +, light phase separation, i.e., minor separation of aqueous and emulsion phases; ++, substantial phase separation; +++, broken emulsion, i.e., with a solid oil layer on the top.

Oil droplet size of the emulsions was measured using a Coulter Counter Model LS 13 320 particle size analyzer (Beckman Coulter Life Sciences, Indianapolis, IN). Other methods of measuring oil droplet size are readily known to persons of ordinary skill in the art. Comparisons of the oil droplet size (Mean and D97 values) measurement were performed for the emulsions at time zero and after an accelerated storage for 1 day at 57° C. These results are shown in the following Table 4. D97 is the oil droplet size where 97% of the total droplet population is smaller than that value.

TABLE 4

| | |
|---|---|
| Oil droplet size: | Oil droplet size: |
| Mean (micron) | D97 (micron) |

| | | 1 day at | | 1 day at |
|---|---|---|---|---|
| Emulsion | Time 0 | 57° C. | Time 0 | 57° C. |
| I | 0.5 | 0.5 | 0.6 | 0.6 |
| I′ | 0.5 | 0.5 | 0.8 | 0.7 |
| II′ | 0.5 | 0.7 | 0.8 | 1.1 |
| III′ | 0.5 | 0.7 | 0.8 | 1.1 |
| IV′ | No data | No data | No data | No data |

Surprising and unexpected results. As shown in Table 4, Emulsion I of this invention surprisingly and unexpectedly showed both smaller time zero mean droplet size and D97 droplet size when compared to comparative emulsions I′-IV′. Emulsion I also showed the smallest oil droplet size growth, i.e., Emulsion I showed no increases of the mean drop size and D97 droplet size after an accelerated storage for 1 week at 57° C. unlike the other emulsions. Because Emulsion IV′ was not formed properly (oiling off), oil droplet size data were unavailable as they could not be correctly measured for the emulsion at time zero and after storage.

Quantifications of Arabinogalactan-Protein and Arabinogalactan. Except for SPRAYGUM™ BE, the weight percent of arabinogalactan-protein and arabinogalactan and molecular weight (MW) of arabinogalactan-protein for each gum acacia was determined using WATERS Alliance 2695 High Performance Liquid Chromatography (HPLC) system under the conditions presented in Table 5 as follows. Other methods of determining weight percentage are readily known to persons of ordinary skill in the art.

TABLE 5

| Columns | Four SHODEX Size Exclusion columns | |
|---|---|---|
| | (SEC): two KD-806M, one KD-802, one KD-801 | |
| Column Temperature | 50° | C. |
| Mobile phase | N,N′-Dimethyl Acetamide (DMAc) with | |
| | 0.11% LiCl | |
| Injection volume | 100 | μL |
| Flow rate | 0.5 | mL/minute |
| Isocratic run time | 100 | minutes |
| Detector | WATERS Differential Refractometer (DR) | |
| | 2414, WYATT multiangle light | |
| | scattering photometer HELEOS II ™ 18 | |
| | angles, and WYATT differential | |
| | capillary viscometer VISCOSTAR ™ 3 | |
| Detector | 50° | C. |

| | |
|---|---|
| Temperature | |
| Software | WYATT Astra v. 7.1 |

Each sample was analyzed in duplicate, and the results are presented in the following Tables 6 and 7.

TABLE 6

| | | | Weight (%) ratio |
|---|---|---|---|
| Gum Acacia | AGP (wt %) | AG (wt %) | of AGP:AG |
| TICALOID ® Acacia | 23.8 | 76.2 | 0.31 |
| MAX | | | |
| INSTANTGUM ™ AA | 11.2 | 88.8 | 0.13 |
| EFICACIA ™ XE | 13.8 | 86.2 | 0.16 |
| SUPERSTAB ™ | 15.7 | 84.3 | 0.19 |

AG, Arabinogalactan; AGP, Arabinogalactan-protein.

TABLE 7

| | | Zeta Potential | | | |
|---|---|---|---|---|---|
| Gum Acacia | AGP MW (Dalton) | pH 6 | | pH 2 | |
| TICALOID ® | 5.9 × 10⁶ | −28.4 | mV | −5.4 | mV |
| Acacia MAX | | | | | |
| INSTANTGUM ™ | 2.1 × 10⁶ | −27.0 | mV | −4.5 | mV |
| AA | | | | | |
| EFICACIA ™ XE | 2.5 × 10⁶ | −27.6 | mV | −4.1 | mV |
| SUPERSTAB ™ | 4.1 × 10⁶ | −27.5 | mV | −3.2 | mV |

AGP, Arabinogalactan-protein.
Data showed that TICALOID ® Acacia MAX has the highest weight (%) ratio of Arabinogalactan-protein to Arabinogalactan and the largest molecular weight in comparison to other three gum acacia.

### Example 3: Emulsions Using Different Amounts of Gum Acacia

A flavor emulsion of one example of this invention, i.e., Emulsion II, was prepared following the same procedure of Emulsion I except that the level of TICALOID® Acacia MAX in the composition was reduced from 75 grams to 50 grams as shown in the following Table 8. Emulsion III, Emulsion IV, Emulsion V of this invention were prepared following the same procedure except that the level of TICALOID® Acacia MAX in the composition was increased from 75 grams to 100 grams, 125 grams, and 156 grams, respectively. Preservatives used in this example are a mixture of potassium sorbate and sodium benzoate.

TABLE 8

Amount in grams

| Component | II | III | IV | V |
|---|---|---|---|---|
| Water | 800.4 | 750.4 | 725.4 | 694.4 |
| TICALOID ® Acacia MAX | 50 | 100 | 125 | 156 |
| Citric acid | 2.5 | 2.5 | 2.5 | 2.5 |
| Preservatives | 4.1 | 4.1 | 4.1 | 4.1 |
| Steviol-based compounds | 18 | 18 | 18 | 18 |
| Oil phase | 125 | 125 | 125 | 125 |

Stability and Droplet Size. Physical stability of the flavor emulsion of this invention, i.e., Emulsion I, at time zero and after storage for 4 weeks at 40° C. was compared with that of Emulsion II, Emulsion III, Emulsion IV, and Emulsion V as shown in Table 9 as follows. Oil droplet size measurement was carried out as described in Example 2.

TABLE 9

Physical stability

| Emulsion | Time 0 | 4 weeks at 40° C. |
|---|---|---|
| I | − | ++ |
| II | − | ++ |
| III | − | + |
| IV | − | + |
| V | − | − |

−, no phase separation;
+, light phase separation, i.e., minor separation of aqueous and emulsion phases;
++, substantial phase separation.

Comparisons of the oil droplet size (Mean and D97 values) measurement performed for the emulsions at time zero and after an accelerated storage for 1 day at 57° C. are shown in the following Table 10.

TABLE 10

| | |
|---|---|
| Oil droplet size: | Oil droplet size: |
| Mean (micron) | D97 (micron) |

| | | 1 day at | | 1 day at |
|---|---|---|---|---|
| Emulsion | Time 0 | 57° C. | Time 0 | 57° C. |
| I | 0.5 | 0.5 | 0.7 | 0.6 |
| II | 0.6 | 0.6 | 1.0 | 1.0 |
| III | 0.4 | 0.4 | 0.6 | 0.6 |
| IV | 0.4 | 0.4 | 0.6 | 0.6 |
| V | 0.4 | 0.4 | 0.6 | 0.6 |

As shown in Tables 9 and 10, to render an emulsion that contains 125 grams of oil phase stable at both time zero and in storage, the minimal level of TICALOID® Acacia MAX was observed to be 75 grams.

### Example 4: Emulsions Containing Different Arabinogalactan-Protein Content

Gum acacia products sold under the tradenames INSTANTGUM™ AA, EFICACIA™ XE, SUPERSTAB™, and TICALOID® Acacia MAX are respectively composed of 11.2%, 13.8%, 15.7%, 23.8% arabinogalactan-protein by weight. Flavor emulsions of several examples of this invention were prepared following the same procedure of Emulsion I using 1.8% steviol-based taste modifier, 12.5% oil phase, and varying amounts of these four different gum acacia sources, which provided different arabinogalactan-protein contents to the emulsions (Table 11).

TABLE 11

| | % Gum Acacia in | % AGP in | % AGP:oil | % Gum:oil |
|---|---|---|---|---|
| Emulsion | emulsion | emulsion | ratio | ratio |
| VI | 5.0% INSTANTGUM ™ AA | 0.6 | 0.04 | 0.40 |
| VII | 7.5% INSTANTGUM ™ AA | 0.8 | 0.07 | 0.60 |
| VIII | 10.0% INSTANTGUM ™ AA | 1.1 | 0.09 | 0.80 |
| IX | 12.5% INSTANTGUM ™ AA | 1.4 | 0.11 | 1.00 |
| X | 15.6% INSTANTGUM ™ AA | 1.7 | 0.14 | 1.25 |
| XI | 20.8% INSTANTGUM ™ AA | 2.3 | 0.19 | 1.66 |
| XII | 5.0% EFICACIA ™ XE | 0.7 | 0.06 | 0.40 |
| XIII | 7.5% EFICACIA ™ XE | 1.0 | 0.08 | 0.60 |
| XIV | 10.0% EFICACIA ™ XE | 1.4 | 0.11 | 0.80 |
| XV | 12.5% EFICACIA ™ XE | 1.7 | 0.14 | 1.00 |
| XVI | 15.6% EFICACIA ™ XE | 2.2 | 0.17 | 1.25 |
| XVII | 20.8% EFICACIA ™ XE | 2.9 | 0.23 | 1.66 |
| XVIII | 5.0% SUPERSTAB ™ | 0.8 | 0.06 | 0.40 |
| XIX | 7.5% SUPERSTAB ™ | 1.2 | 0.09 | 0.60 |
| XXI | 10.0% SUPERSTAB ™ | 1.6 | 0.13 | 0.80 |
| XXII | 12.5% SUPERSTAB ™ | 2.0 | 0.16 | 1.00 |
| XXIII | 15.6% SUPERSTAB ™ | 2.4 | 0.20 | 1.25 |
| XXIV | 20.8% SUPERSTAB ™ | 3.3 | 0.26 | 1.66 |
| XXV | 5.0% TICALOID ® | 1.2 | 0.10 | 0.40 |
| | Acacia MAX | | | |
| XXVI | 7.5% TICALOID ® Acacia | 1.8 | 0.14 | 0.60 |
| | MAX | | | |
| XXVII | 10.0% TICALOID ® | 2.4 | 0.19 | 0.80 |
| | Acacia MAX | | | |
| XXVIII | 12.5% TICALOID ® | 3.0 | 0.24 | 1.00 |
| | Acacia MAX | | | |
| XXIX | 15.6% TICALOID ® | 3.7 | 0.30 | 1.25 |
| | Acacia MAX | | | |
| XXX | 20.8% TICALOID ® | 5.0 | 0.40 | 1.66 |
| | Acacia MAX | | | |

AGP, Arabinogalactan-protein.

Stability and Droplet Size. Physical stability and viscosity (determined using a Brookfield Viscometer (Model DV-III) with Spindle #4 at a speed of 60 rpm) of the flavor emulsions after storage for 4 weeks at 40° C. were compared (Table 12). Other methods of determining physical stability and viscosity are readily known to persons of ordinary skill in the art.

TABLE 12

| | Physical stability | | |
|---|---|---|---|
| | | 4 weeks at | Viscosity |
| Emulsion | Time 0 | 40° C. | (cPs) |
| VI | − | ++ | 13 |
| VII | − | ++ | 17 |
| VIII | − | ++ | 23 |
| IX | − | + | 33 |
| X | − | + | 53 |
| XI | − | − | 137 |
| XII | − | ++ | 20 |
| XIII | − | ++ | 23 |
| XIV | − | + | 33 |
| XV | − | + | 60 |
| XVI | − | − | 167 |
| XVII | − | − | 440 |
| XVIII | − | ++ | 10 |
| XIX | − | ++ | 17 |
| XXI | − | + | 30 |
| XXII | − | + | 53 |
| XXIII | − | + | 103 |
| XXIV | − | − | 273 |
| XXV | − | ++ | 17 |
| XXVI | − | ++ | 25 |
| XXVII | − | + | 40 |
| XXVIII | − | + | 70 |
| XXIX | − | − | 144 |
| XXX | − | − | 416 |

−, no phase separation;
+, light phase separation, i.e., minor separation of aqueous and emulsion phases;
++, substantial phase separation.

Oil droplet size measurement was carried out as described in Example 2. Comparisons of the oil droplet size (Mean and D97 values) measurement performed for the emulsions at time zero, after an accelerated storage for 1 day at 57° C., or storage for 6 weeks at 40° C. are shown in Table 13.

TABLE 13

| | Oil droplet size: | | | Oil droplet size: | | |
|---|---|---|---|---|---|---|
| | Mean (micron) | | | D97 (micron) | | |
| | Time | 1 day | 6 weeks | Time | 1 day | 6 weeks |
| Emulsion | 0 | at 57° C. | at 40° C. | 0 | at 57° C. | at 40° C. |
| VI | 0.6 | 0.6 | 0.5 | 1.0 | 1.0 | 0.8 |
| VII | 0.5 | 0.5 | 0.5 | 0.8 | 0.7 | 0.7 |
| VIII | 0.4 | 0.4 | 0.5 | 0.6 | 0.6 | 0.7 |
| IX | 0.4 | 0.4 | 0.4 | 0.6 | 0.6 | 0.6 |
| X | 0.4 | 0.4 | 0.4 | 0.6 | 0.6 | 0.6 |
| XI | 0.4 | 0.3 | 0.4 | 0.6 | 0.7 | 0.7 |
| XII | 0.7 | 0.9 | 0.8 | 1.1 | 1.5 | 1.3 |
| XIII | 0.5 | 0.7 | 0.7 | 0.8 | 1.1 | 1.1 |
| XIV | 0.4 | 0.5 | 0.5 | 0.6 | 1.0 | 0.8 |
| XV | 0.4 | 0.6 | 0.5 | 0.6 | 1.0 | 0.9 |
| XVI | 0.4 | 0.7 | 0.7 | 0.7 | 1.2 | 1.2 |
| XVII | 0.4 | 0.6 | 0.6 | 0.7 | 1.1 | 1.4 |
| XVIII | 0.6 | 0.8 | 0.8 | 1.1 | 1.2 | 1.2 |
| XIX | 0.5 | 0.7 | 0.7 | 0.8 | 1.1 | 1.0 |
| XXI | 0.5 | 0.7 | 0.6 | 0.8 | 1.1 | 1.0 |
| XXII | 0.5 | 0.7 | 0.6 | 1.1 | 1.2 | 1.0 |
| XXIII | 0.5 | 0.7 | 0.6 | 1.1 | 1.2 | 1.1 |
| XXIV | 0.5 | 0.8 | 0.8 | 1.2 | 1.8 | 1.7 |
| XXV | 0.6 | 0.6 | 0.7 | 1.0 | 1.0 | 1.0 |
| XXVI | 0.5 | 0.5 | 0.5 | 0.6 | 0.6 | 0.7 |
| XXVII | 0.4 | 0.4 | 0.5 | 0.6 | 0.6 | 0.7 |
| XXVIII | 0.4 | 0.4 | 0.4 | 0.6 | 0.6 | 0.6 |
| XXIX | 0.4 | 0.4 | 0.5 | 0.6 | 0.6 | 0.7 |
| XXX | 0.3 | 0.4 | 0.4 | 0.5 | 0.6 | 0.6 |

As shown in Tables 12 and 13, Emulsion X, Emulsion XI, Emulsion XXVII, Emulsion XXVIII, Emulsion XXIX, and Emulsion XXX showed good emulsion physical stability, i.e., no phase separation and/or light phase separation after storage for 4 weeks at 40° C. and excellent droplet size stability, i.e., no increases of both mean droplet size and D97 droplet size after an accelerated storage for 1 day at 57° C. These results are indicative of an exemplary stable emulsion of the invention at a suitable viscosity (i.e., greater than 30 cPs) when the % by weight of arabinogalactan-protein was greater than 1.5%, the % arabinogalactan-protein to oil ratio was at least 0.1 and/or the % gum acacia to oil ratio was at least 0.8.

### Example 5: Addition of Amphiphilic Taste Modifier in the First Aqueous Phase and Failed Results

To demonstrate the negative effect of adding the amphiphilic taste modifier in the first aqueous phase, flavor emulsions of examples of this invention were prepared following the same procedure of Emulsion I, except that the steviol-based compounds at 1.8% or 0.9% (Table 14) were added in the first aqueous phase prior to a high shear mixing with the oil phase.

TABLE 14

| | | |
|---|---|---|
| | | Equivalent % |
| | | TICALOID ® Acacia |
| Emulsion | % Gum Acacia in emulsion | MAX based on AGP |

1.8% Steviol-based compounds

| | | |
|---|---|---|
| XXXI | 10.0% INSTANTGUM ™ AA | 4.7 |
| XXXII | 21.25% INSTANTGUM ™ AA | 10.0 |
| XXXIII | 10.0% EFICACIA ™ XE | 5.8 |
| XXXIV | 17.25% EFICACIA ™ XE | 10.0 |
| XXXV | 10.0% SUPERSTAB ™ | 6.6 |
| XXXVI | 15.16% SUPERSTAB ™ | 10.0 |
| XXXVII | 10.0% TICALOID ® Acacia MAX | 10.0 |
| XXXVIII | 12.5% TICALOID ® Acacia MAX | 12.5 |
| XXXIX | 15.6% TICALOID ® Acacia MAX | 15.6 |

0.9% Steviol-based compounds

| | | |
|---|---|---|
| XL | 10.0% INSTANTGUM ™ AA | 4.7 |
| XLI | 10.0% EFICACIA ™ XE | 5.8 |
| XLII | 10.0% SUPERSTAB ™ | 6.6 |
| XLIII | 4.7% TICALOID Acacia MAX | 4.7 |
| XLIV | 6.6% TICALOID Acacia MAX | 6.6 |
| XLV | 10.0% TICALOID Acacia MAX | 10.0 |

AGP, Arabinogalactan-protein

Stability and Droplet Size. Physical stability and oil droplet size measurements were determined as described previously in Example 2 and the results are presented in the following Table 15.

TABLE 15

| | Oil droplet | | Oil droplet | | | |
|---|---|---|---|---|---|---|
| | size: Mean | | size: D97 | | Physical | |
| | (micron) | | (micron) | | stability | |
| | Time | 1 day | | 1 day | Time | 4 weeks |
| Emulsion | 0 | at 57° C. | Time 0 | at 57° C. | 0 | at 40° C. |
| XXXI | 27.8 | no data | 51.5 | no data | +++ | +++ |
| XXXII | 18.6 | no data | 37.8 | no data | +++ | +++ |
| XXXIII | 11.3 | no data | 27.7 | no data | +++ | +++ |
| XXXIV | 9.3 | no data | 21.0 | no data | +++ | +++ |
| XXXV | 11.5 | no data | 28.8 | no data | +++ | +++ |
| XXXVI | 7.5 | no data | 17.4 | no data | +++ | +++ |
| XXXVII | 17.6 | no data | 39.1 | no data | +++ | +++ |
| XXXVIII | 16.1 | no data | 38.1 | no data | +++ | +++ |
| XXXIX | 15.9 | no data | 39.5 | no data | +++ | +++ |
| XL | 4.0 | 3.0 | 7.0 | 6.0 | +++ | +++ |
| XLI | 3.7 | 2.7 | 7.3 | 6.5 | +++ | +++ |
| XLII | 3.4 | 2.9 | 5.7 | 5.2 | +++ | +++ |
| XLIII | 9.1 | 5.7 | 17.8 | 12.4 | +++ | +++ |
| XLIV | 7.6 | 7.2 | 13.1 | 11.2 | +++ | +++ |
| XLV | 7.0 | 6.9 | 12.3 | 11.2 | +++ | +++ |

+++, broken emulsion, i.e., with a solid oil layer on the top.

Notably, the addition of the amphiphilic taste modifier did not provide a mean droplet size of less than 1 μm and consistently broke the emulsion, independent of the amount of taste modifier included. These results demonstrate the criticality of adding the amphiphilic taste modifier after the emulsion is formed. This is because a taste modifier that is a steviol-based taste modifier is amphiphilic and prevents formation of to an emulsion by leading destabilization. Oil droplet size data of some samples were unavailable as they could not be correctly measured for the emulsion after storage.

### Example 6: Inclusion of a Co-Emulsifier

A flavor emulsion of one example of this invention, i. e., Emulsion XLVI, was prepared following the same procedure of Emulsion I except that the level of TICALOID® Acacia MAX in the composition was reduced from 75 grams to 50 grams and INSTANTGUM™ AA was added as a co-emulsifier in a first aqueous phase where the total level of gum acacia was 156 grams as shown in Table 16. Both TICALOID® Acacia MAX and INSTANTGUM™ AA are amphiphilic ingredients but they do not prevent formation of an emulsion. Emulsion XLVII and Emulsion XLVIII of examples of this invention were prepared following the same procedure as Emulsion I except that the level of TICALOID® Acacia MAX in the composition was increased from 50 grams to 75 grams and 100 grams, respectively, and the level of INSTANTGUM™ AA co-emulsifier was reduced from 106 grams to 81 grams and 56 grams, respectively. Preservatives used in this example are a mixture of potassium sorbate and sodium benzoate.

TABLE 16

Amount in grams

| Component | XLVI | XLVII | XLVIII |
|---|---|---|---|
| Water | 694.4 | 694.4 | 694.4 |
| TICALOID ® Acacia | 50 | 75 | 100 |
| MAX | | | |
| INSTANTGUM ™ AA | 106 | 81 | 56 |
| Citric acid | 2.5 | 2.5 | 2.5 |
| Preservatives | 4.1 | 4.1 | 4.1 |
| Steviol-based | 18 | 18 | 18 |
| compounds | | | |
| Oil phase | 125 | 125 | 125 |

Stability and Droplet Size. Physical stability of the flavor emulsions of this invention, i.e., Emulsion XLVI, Emulsion XLVII, Emulsion XLVIII, at time zero and after storage for 4 weeks at 40° C. was compared as shown in Table 17.

TABLE 17

Physical stability

| Emulsion | Time 0 | 4 weeks at 40° C. |
|---|---|---|
| XLVI | − | + |
| XLVII | − | + |
| XLVIII | − | + |

−, no phase separation;
+, light phase separation, i.e., minor separation of aqueous and emulsion phases.

Surprising and unexpected results. Oil droplet size measurement was carried out as described in Example 2. Comparisons of the oil droplet size (Mean and D97 values) measurement performed for the emulsions at time zero and after an accelerated storage for 1 day at 57° C. are shown in Table 18.

TABLE 18

| | |
|---|---|
| Oil droplet size: Mean | Oil droplet size: D97 |
| (micron) | (micron) |

| | | 1 day at | | 1 day at |
|---|---|---|---|---|
| Emulsion | Time 0 | 57° C. | Time 0 | 57° C. |
| XLVI | 0.4 | 0.4 | 0.6 | 0.6 |
| XLVII | 0.4 | 0.4 | 0.6 | 0.6 |
| XLVIII | 0.4 | 0.4 | 0.6 | 0.6 |

As shown in Tables 17 and 18, Emulsion XLVI, Emulsion XLVII, and Emulsion XLVIII of this invention surprisingly and unexpectedly showed exceptional time zero performance as well as emulsion physical stability, i.e., minor phase separation, and oil droplet size stability, i.e., no increases of the mean droplet size and D97 droplet size after storage.

### Example 7: Modulation of Co-Emulsifier Amounts

Flavor emulsions of examples of this invention were prepared following the same procedure of Emulsion I (12.5% oil phase), with 1.8 wt % taste modifier added in the second aqueous phase and varying amounts of TICALOID® Acacia MAX in combination with INSTANTGUM™ AA as co-emulsifier (Table 19).

TABLE 19

| | % Gum Acacia in | | Equivalent % | | |
|---|---|---|---|---|---|
| | emulsion | | TICALOID ® | | |
| | TICALOID ® | | Acacia MAX | | |
| | Acacia | INSTANTGUM ™ | based on | % AGP:oil | % gum:oil |
| Emulsion | MAX | AA | AGP | ratio | ratio |
| XLIX | 7.5 | 5.3 | 10.0 | 0.19 | 1.02 |
| L | 5.0 | 10.6 | 10.0 | 0.19 | 1.25 |
| LI | 7.5 | 8.1 | 11.3 | 0.22 | 1.25 |
| LII | 10.0 | 5.6 | 12.6 | 0.24 | 1.25 |
| LIII | 7.5 | 13.3 | 13.8 | 0.26 | 1.66 |
| LIV | 10.0 | 10.8 | 15.1 | 0.29 | 1.66 |

AGP, Arabinogalactan-protein.

Stability and Droplet Size. Physical stability and viscosity (determined using a Brookfield Viscometer (Model DV-III) with Spindle #4 at a speed of 60 rpm) of the flavor emulsions after storage for 4 weeks at 40° C. were compared (Table 20). Other ways of measuring physical stability and viscosity are readily known to persons of ordinary skill in the art.

TABLE 20

| | Physical stability | | |
|---|---|---|---|
| | | 4 weeks at | Viscosity |
| Emulsion | Time 0 | 40° C. | (cPs) |
| XLIX | − | + | 72 |
| L | − | + | 80 |
| LI | − | + | 83 |
| LII | − | + | 93 |
| LIII | − | − | 133 |
| LIV | − | − | 217 |

−, no phase separation;
+, light phase separation;
++, substantial phase separation.

Oil droplet size measurement was carried out as described in Example 2. Comparisons of the oil droplet size (Mean and D97 values) measurement performed for the emulsions at time zero, after an accelerated storage for 1 day at 57° C., or storage for 6 weeks at 40° C. are shown in Table 21.

TABLE 21

| | Oil droplet size: | | | Oil droplet size: | | |
|---|---|---|---|---|---|---|
| | Mean (micron) | | | D97 (micron) | | |
| | Time | 1 day | 6 weeks | Time | 1 day | 6 weeks |
| Emulsion | 0 | at 57° C. | at 40° C. | 0 | at 57° C. | at 40° C. |
| XLIX | 0.5 | 0.5 | 0.5 | 0.7 | 0.7 | 0.7 |
| L | 0.4 | 0.5 | 0.5 | 0.6 | 0.7 | 0.7 |
| LI | 0.4 | 0.4 | 0.4 | 0.6 | 0.6 | 0.6 |
| LII | 0.4 | 0.4 | 0.4 | 0.6 | 0.6 | 0.6 |
| LIII | 0.4 | 0.4 | 0.4 | 0.6 | 0.6 | 0.6 |
| LIV | 0.4 | 0.4 | 0.4 | 0.6 | 0.6 | 0.6 |

As shown in Tables 20 and 21, emulsions of examples of this invention including a combination of emulsifiers showed exceptional time zero performance as well as demonstrated physical and oil droplet size stability after storage.

### Example 8: Use of Emulsion in a Beverage Product

A beverage of one example of this invention, i.e., Beverage A, was prepared following the procedure described below. More specifically, 0.1% (wt/vol) of Emulsion I was mixed with a non-alcoholic beverage solution, which was prepared with the formulation shown in Table 22. Beverages B, C, D, E, F, G, and H of examples of this invention were prepared using Emulsions III, IV, V, XLVI, XLVII, XLVIII, and LIII, respectively, following of the procedure Beverage A except that the different emulsions were used.

Three hundred grams of each beverage was placed in a clear 10-oz glass bottle and stored horizontally over a period of 6 weeks at ambient temperature. The stability of the seven beverages was monitored and it was observed that all beverage samples exhibited excellent stability without signs of creaming or ringing.

TABLE 22

| Ingredient | Gram/Liter |
|---|---|
| Emulsion I | 1 |
| Sugar syrup 74° Brix | 86 |
| Citric acid | 1.2 |
| Sodium benzoate | 0.2 |
| Water | q.s. to 1 Liter |

A beverage of an example of this invention, i.e., Beverage I, was prepared using Emulsion I following the same procedure of Beverage A, except that sugar syrup 74° Brix was increased to 122 grams in the beverage composition. Beverages J, K, L, M, N, and O of examples of this invention were prepared following the same procedure of Beverage I (i.e., increasing the sugar syrup 74° Brix to 122 grams) except that Emulsions III, IV, V, XLVI, XLVII, XLVIII, and LIII were used, respectively.

Three hundred grams of each beverage was placed in a clear 10-oz glass bottle and stored horizontally over a period of 6 weeks at ambient temperature. The stability of the beverages was monitored and it was observed that all beverage samples exhibited excellent stability without signs of creaming or ringing.

The claims are not limited by the preferred embodiments and examples but will cover many modifications and equivalents consistent with the written description as a whole.

What is claimed is:

1. An oil-in-water emulsion comprising:
(i) an oil phase comprising at least one first functional ingredient, the at least one first functional ingredient being a flavor oil, a weighting agent, a lipid, an antioxidant, an opacifier/cloudifier, or a combination of any of the foregoing,
(ii) a first aqueous phase comprising at least one acacia gum emulsifier comprising arabinogalactan-protein, and
(iii) a second aqueous phase comprising at least one second functional ingredient, the at least one second functional ingredient being a taste modifier, an acidulant, a preservative, a carbohydrate, a nutraceutical ingredient, a colorant, a juice, a plant extract, a vitamin, or a combination of any of the foregoing, wherein the oil-in-water emulsion comprises a plurality of oil droplets each having a mean droplet size of from about 0.1 μm to about 1 μm in diameter, and the weight ratio of arabinogalactan-protein to oil is at least 1:10.

2. The oil-in-water emulsion of claim 1, wherein the arabinogalactan-protein content of the emulsion is at least 1.0% w/w by weight.

3. The oil-in-water emulsion of claim 1, wherein the weight ratio of acacia gum emulsifier to oil is at least 1:1.3.

4. The oil-in-water emulsion of claim 1, wherein the viscosity of the emulsion is at least 30 cPs.

5. The oil-in-water emulsion of claim 1, wherein the taste modifier is a sweetness modifier.

6. The oil-in-water emulsion of claim 5, wherein the sweetness modifier is a steviol-based compound, a non-steviol-based compound or a combination of any of the foregoing.

7. The oil-in-water emulsion of claim 1, wherein the second functional ingredient is present in an amount of from about 0.1% to about 5% w/w by weight of the oil-in-water emulsion.

8. The oil-in-water emulsion of claim 1, further comprising a co-emulsifier.

9. The oil-in-water emulsion of claim 8, wherein the co-emulsifier is a second acacia gum emulsifier.

10. A method of preparing an oil-in-water emulsion, the method comprising the steps of:
(a) emulsifying a first aqueous phase with an oil phase thereby obtaining an oil-in-water emulsion, the oil phase comprising at least one first functional ingredient, the at least one first functional ingredient being a flavor oil, a weighting agent, a lipid, an antioxidant, an opacifier/cloudifier, or a combination of any of the foregoing, and the first aqueous phase comprising at least one acacia gum emulsifier comprising arabinogalactan-protein, and
(b) admixing a second aqueous phase with the oil-in-water emulsion to form a final oil-in-water emulsion, the second aqueous phase comprising at least one second functional ingredient, the at least one second functional ingredient being a taste modifier, an acidulant, a preservative, a carbohydrate, a nutraceutical ingredient, a colorant, a juice, a plant extract, a vitamin, or a combination of any of the foregoing,
wherein the final oil-in-water emulsion comprises a plurality of oil droplets each having a mean droplet size of from about 0.1 μm to about 1 μm in diameter, and the weight ratio of arabinogalactan-protein to oil is at least 1:10.

11. The method of claim 10, wherein the emulsifying step comprises high pressure homogenization.

12. The method of claim 10, wherein the arabinogalactan-protein content of the oil-in-water emulsion is at least 1.0% w/w by weight.

13. The method of claim 10, wherein the weight ratio of acacia gum emulsifier to oil is at least 1:1.3.

14. The method of claim 10, wherein the viscosity of the oil-in-water emulsion is at least 30 cPs.

15. The method of claim 10, wherein the taste modifier is a sweetness modifier.

16. The method of claim 10, further comprising a co-emulsifier.

17. The method of claim 16, wherein the co-emulsifier is a second acacia gum emulsifier.

18. The method of claim 10, wherein the step of emulsifying the first aqueous phase with an oil phase further comprises a step of providing the first aqueous phase with the at least one second functional ingredient, wherein the at the least one second functional ingredient is non-amphiphilic.

19. The oil-in-water emulsion of claim 1, wherein the oil phase comprising the at least one first functional ingredient includes the at least one second functional ingredient in the first aqueous phase, wherein the at least one second functional ingredient is non-amphiphilic.
